(19) United States
(12) Patent Application Publication
(10) Pub. No.: US 2003/0018568 A1
(43) Pub. Date: Jan. 23, 2003

(54) Secure network system for mutual aid loan association and data processing method of the same

(76) Inventor: Jay Chieh Chen, San Marino, CA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/162,707

(22) Filed: Jun. 6, 2002

(30) Foreign Application Priority Data
Jun. 6, 2001 (CN) 011157526.6

(51) Int. Cl. G06F 17/60

(52) U.S. Cl. 705/37; 705/36; 705/38

(57) ABSTRACT

A secure network system of association of mutual aid loan and the data processing method of the same are disclosed. In the system of the present invention, the association web site controls and manages the anonymous bidding of each of the association feet to the web site, anonymous opening of the bid, and each of the association feet paying the association fund to the association web site and the web site paying the collected total fund to the winner foot, or each of the feet paying individually the association fund to the winner foot. The messages and electronic contracts being communicated between the association web site and each of the feet are encrypted and decrypted by using keys and digital signatures so as to protect from fraudulent bid by real (false) association feet. Each of the feet may change his/her amount of bidding money with unlimited times before the closing date and opening of the bid of each term of the association. The association foot downloads the association list set by other feet and negotiates the contents and conditions of the association list via the network using peer to peer mode.

### BACKGROUND OF THE INVENTION

1. Field of the Invention

The present invention relates to a network system for implementing mutual aid borrowing and lending, and more particularly, to a secure network system for mutual aid loan bidding among borrowers/lenders and borrowers/lenders.

2. Description of the Prior Art

The association of mutual aid loan is also referred to as benefit association, followers association or participants association (hereinafter referred to as “association”) which has been being an important financial management means of the Oriental families since the ancient age, it was said that associations of mutual aid loan were started in the Wei, Jin, Northern and Southern dynasties. As a financial management means combining savings and raising fund, the functionality of the association of mutual aid loan is to gain interests and raise fund. The association of mutual aid loan does not require its members to give any guarantee, is easy to raise fund, pays higher interest than that from a bank, and the lower the environmental prosperity, the higher the repayment benefit rate of the association of mutual aid loan will be. A “foot” of the association of mutual aid loan may get certain fund by bidding when he/she needs money, and takes it as total withdrawal with fractional deposits at a bank when he/she does not need money, interests will be paid during each term of the association of mutual aid loan until the whole fund is paid at the end of the last term.

There is usually an initiator, or head of association, in a traditional association of mutual aid loan, the other participants are “feet” of the association, or members. Typically, the head of association invites his relatives, friends, neighbors, or colleagues to participate in the association. After the forming of an association, the participants will meet together at a fixed location periodically (every month or half a month) to collect fund. During the meeting, the money that should be paid by the members each time is called association fund, and the sum of the association fund of each term is called total association fund, the total association fund that can be raised from the feet of the association by the winner of the bidding depends on the number of feet. Association fund can be money or other alternatives, it depends on the stipulations of the tax law whether the interest income or expenditure of the association should be listed as income tax by each of the feet respectively. Usually the first total association fund is collected from the whole association fund paid by each foot at the initiation of the association and given to the head of the association without bidding. There will be a lot of disputes which may be harmful to the affection between relatives and friendship, or even causing the downfall of the association, if a foot of the association fails to attend the fixed location to bid in time, or a familiar foot or the head of the association makes a false bidding fraudulently representing a foot or even sentenced by the court as fraud crime, or the feet fail to hand in his/her association fund in time. One of the measures to protect from fraudulent bidding is that all the association feet are requested to sign on the original of an association list, which is copied and signed by the head of the association and delivered to each foot to protect from fraudulent bidding. However, the fraudulent signing by the head of association and other feet for one foot has not yet been avoided which often causes the downfall of the association and the foot to commit suicide or lawsuits between the feet and head of the association.

It is stipulated by the law of Taiwan that items recorded in the association list of the mutual aid loan association include: (1). The name, address, and telephone number of the head of association; (2). The names, addresses, and telephone numbers of all members; (3). The type and basic amount of each share of association fund; (4). Date of foundation of the association; (5). Dates of bidding; (6). Method for bidding; (7). The maximum and minimum limits of bidding money should be in conformity with the stipulations if there is any agreement. There have been no explicit stipulations by the law of the People's Republic of China, The document “Law (Civil) Issue (1991) 21” of the Supreme People's Court on “Opinions Regarding People's Courts' Trials of Debit and Credit Dispute Cases” has been published and implemented on Aug. 13, 1991, this document stipulates the debit and credit (dispute) between citizen, debit and credit (dispute) between citizen and legal person, and debit and credit (dispute) between citizen and other organizations.

There was no patent for invention and any prior art for secure network system for association of mutual aid loan or for carrying out association of mutual aid loan on-line before the present invention. The present invention is a method and system for the use of network anonymous bidding for mutual aid loan in a lending mutual aid association with the members being both lenders and borrowers, which is of the electronic commercial type of borrowers/lenders-to-borrowers/lenders, which does not involve the trade of any real items. However, in some U.S. patents for invention, such as those network auction web sites, and bidding web sites or cooperative purchase bidding websites, all of them relate to advertised items, and a web site participating in the auction is not necessary the winner of the auction, which is also not necessary the winner of bidding, A significant difference is that the winner of an auction web site or the winner of a bidding web site should pay price to the seller who provides the real item, this is in contrast to the secure network association of mutual aid loan, in contrast, every association foot who does not win the bidding and one who won a bidding previously must lend the association fund to the foot who wins the bidding. It is sure that every foot of the secure network association of mutual aid loan will become a winner of a certain term of the association (who will be referred to as a foot of a dead association), the winner will not continue to bid in the remaining bidding terms. The U.S. Pat. No. 5,966,699, Zandi Richard, Oct. 12, 1999, titled “System and Method for Conducting loan Auction over Computer Network”, and the U.S. Pat. No. 5,995,947, Fraser Stephen, Nov. 30, 1999, titled “Interactive Mortgage and Loan Information and Real-Time Trading System” did not use encryption and decryption method, therefore their network security is insufficient, but both have the same object that a borrower inputs a borrowing application into a computer to conduct loan auction, and a plurality of lenders who desired to lend individually input loan biddings into the computer, such that the borrower can determine to accept which bid. However, it is different from the present invention that the feet of an association firstly agree upon the number of feet of an association and make anonymous bids in individual terms, the total number of feet is the number of terms, before the opening of the sealed bid on the date of the first term of an association of mutual aid loan, every foot of the association has both identities as a lender (bidding foot) and a borrower (bidding foot), a foot having already won a bid has only the identity of a lender, the bidding made by a foot at the most recent time of date before the closing date D of a certain term of the association of mutual aid loan is regarded as an effective bidding, and every bid received is decrypted and then the bidding amounts of money of the feet are published by the web site of the association only after the closing date of this term. The present invention has no head of association, this is different from the association with a head existing for centuries. The web site of an association of mutual aid loan controls and manages the anonymous bidding of the feet and anonymous opening of the bids, the association list of an association of mutual aid loan is worked out with the mutual confidence and agreed conditions of the feet before the initiation of the association.

### SUMMARY OF THE INVENTION

It is an object of the present invention to provide a secure network system for association of mutual aid loan and a data processing method of the same to implement association of mutual aid loan over the network, with the web site of the association controlling and managing the anonymous bidding of each foot to that web site, anonymous opening of bids, each foot pays the association fund to the web site of the association, and the web site pays the total association fund to the foot winning the bid after collection of all the funds, or each of the feet pays his/her association fund to the foot winning the bid. The information and electronic contract between the web site of the association and each of the association feet are encrypted and decrypted using keys and digital signatures to protect from fraudulent bidding by real (false) foot. Association feet (natural persons) are users (members) of the web site of the association of mutual aid loan, a foot inputs to the web site of the association an announcement to look for suitable association lists, the association web site receives an association list with legal contents from the Internet as an initiating association foot, association feet may change their bidding amount of money for limitless times before the closing date of each term of the association. An association foot may download any association lists worked out by other feet using peer-to-peer mode via the network, after a negotiation of the contents and condition of the association list, an association list script with mutual confidence and agreement is input into the association web site for implementing the association. The association information used and transmitted in the network of the present invention makes use of keys and digital signatures, and is undeniable, this ensures the integrity of the association information, there will therefore be no fraudulent bidding, and of good network security.

The technical solution of the present invention is that:

The data processing method of a secure network system of the association of mutual aid loan according to the present invention comprises the following steps:

a plurality of terminals are controlled and managed by a web site of the association of mutual aid loan which accepts the users of the terminals as members of that web site, and receives the association list input by each of the terminals;

If the web site determines the association list being tenable, it publishes a message for initiating an association to each of the terminals of the feet of association listed on the list and receives messages of agreement on initiation of the association from them;

The web site receives bidding information input by the terminals of the feet of the association;

When the web site determines that the bid can be opened for this association of mutual aid loan, it outputs an opening message of the bid to the terminals of each of the feet;

If the web site discovers that the association of mutual aid loan can not be continued, it outputs messages for stopping the association to each of the terminals of the feet.

In the present invention, each of the feet of the association of mutual aid loan can make anonymous bidding to the web site via his/her terminal under the control and management of the web site of the association, the web site may carry out anonymous opening of bid, then each of the feet may pay the association fund to the web site to be collected and forwarded to the foot who has won the bid, or each of the feet may pay the association fund to the foot who has won the bid, respectively.

In the present invention, the information and electronic contracts transmitted between the association web site and each of the feet may be encrypted and decrypted using key encryption-decryption method and digital signature to protect against fraudulent bidding by real (false) foot.

A secure network system of association of mutual aid loan according to the present invention comprises:

a web site of the association of mutual aid loan;

a plurality of terminals connected to the web site via a network, those terminals have been registered on the web site as foot members of the association and controlled and managed by the web site, each of them being configured with an association software and a browser software; and

means for connecting said terminal to the server of the web site of the association via the Internet;

wherein an association list set by mutual confidence and agreement of more than three terminals of the feet is input to the association web site server by one terminal of a foot member listed in the list;

the association web site server determines that the association list is in conformity with the provisions of relevant laws on association of mutual aid loan and that each of foot member's terminal on the association list agrees to initiate an association of mutual aid loan, the association web site accepts the bidding of the terminals of the feet of association on the list who have not won any bid, determines the winner of the bid of each term of the association, updates and publishes the results of the process of the association and information on the flowing of the association funds.

In the system of the present invention, the association foot terminal may further use the encryption and decryption software stored in the foot's IC smart card to carry out message encryption and decryption, using the IC smart card to store digital certificate and making digital signature using the secret key of the association foot in the IC smart card.

The present invention may utilize non-symmetric public key cryptography, digital certificate and digital signature. By checking the digital signature made by the certificate authority, validity of the digital certificate (electronic identification) of the association foot is determined. The use of an IC smart card such as integrated IC smart card to store the keys and digital certificates may combine credit card, deposit card and mobile electronic commerce.

The features of the present invention are:

(i) An association foot is a registered user of the web site of the association of mutual aid loan; a qualified association list negotiated by the feet via the network (e.g., Internet) is presented to the web site of the association to initiate an association, instead of the head of the association and the deliverers in traditional associations of mutual aid loan, it is no more necessary for the association feet to gather together at the same association location, the association feet make and open anonymous biddings via the network, the association messages using keys and digital signatures is undeniable and integrate, therefore, there will be no fraudulent biding, and the network is of good security.

(ii) An association foot may change his/her bidding amount of money any times before the closing date and opening of the bid of each term of the association.

(iii) The paths of the flowing of funds in each term of the association: 1. each of the association feet pays the fund to the web site of the association before the time limit of payment of the fund, then the web site of the association pays the total fund to the foot who wins the bid, or 2, each of the feet individually pays his/her fund to the association foot who wins the bid by himself/herself and inputs the materials about the flowing of funds into the web site of the association, which publishes them there after, and the association foot who wins the bid inputs the materials on the acknowledgement of receipt of each amount of fund.

(iv) If the association of mutual aid loan can not be continued because of more than one association feet failing to pay the fund on certain association term date or other events, according to the provisions of the law of association in Taiwan, the feet who have already won a bid should pay the average amount of fund of each term that they should pay to the feet who have not win any bid on the date of each term of the association, or the feet who have already won a bid should return the total amount of association fund that he/she won from a bid to the association feet who have not yet won any bid within the time limit agreed on in the association list, each of the association feet having already won a bid pays or returns the association fund in the reverse path of the flowing path of the association fund and then inputs the materials on the flowing of fund into the web site of the association which publishes them, then each of the feet inputs the acknowledgment of the materials on the flowing of each amount of fund into the web site of the association.

### BRIEF DESCRIPTION OF THE DRAWINGS

The present invention will be explained in detail in the fallowing in conjunction with the accompanying drawings and embodiments.

FIG. 1 is a schematic diagram of the structure of a secure network system of the association of mutual aid loan according to the present invention;

FIGS. 2A and 2B are flow charts of specific embodiments of a method of the secure network association of mutual aid loan according to the present invention.

### DETAILED DESCRIPTION OF THE INVENTION

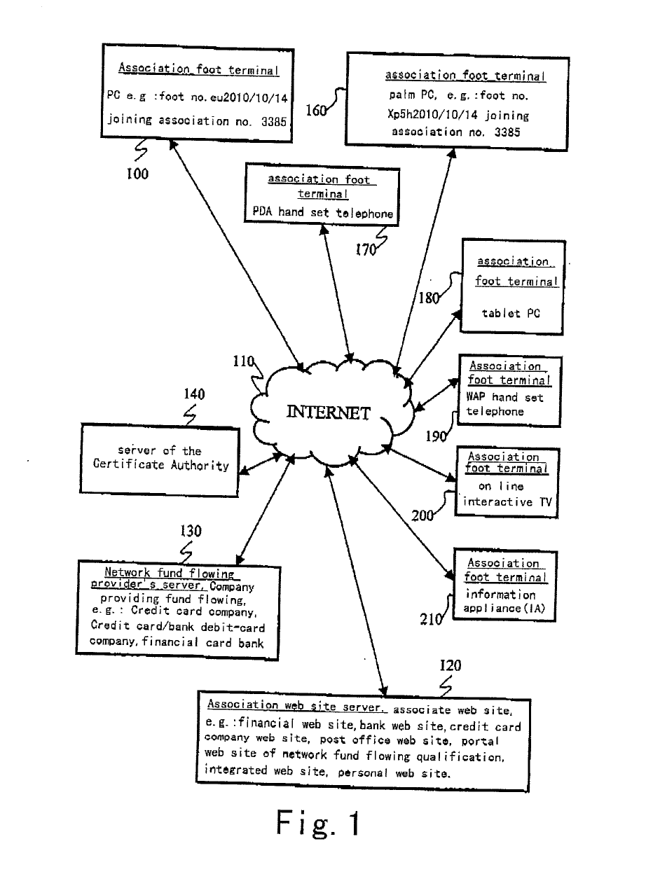

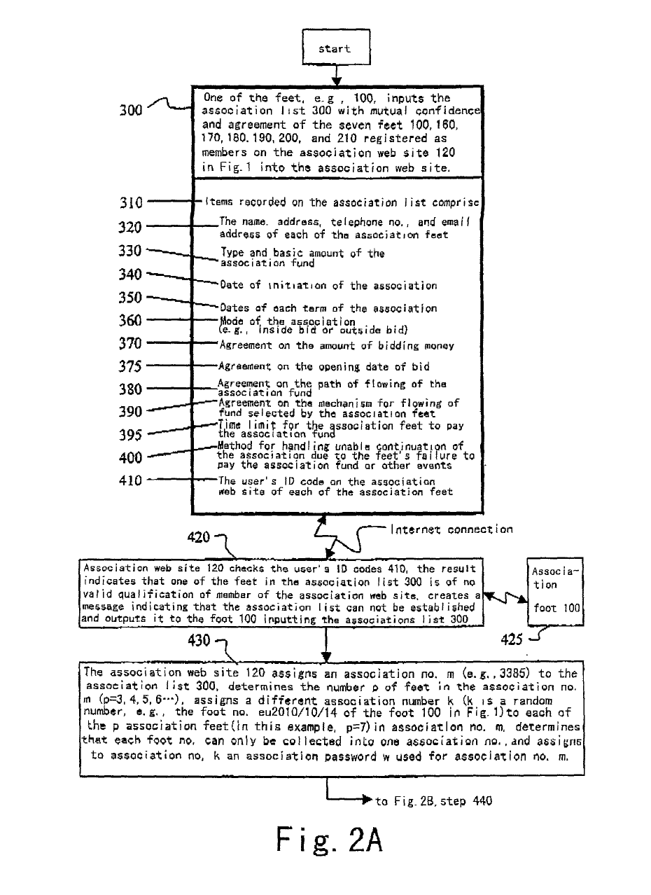

As shown in FIG. 1, the connection method used by the terminals of the present invention to register on the Internet 110 may be a wired connection or wireless connection, the frequency width for accessing the network may be broad band or non-broad band. The browser used by the terminal accessing the network may be, for example, the Netscape Communicator, the IE Explorer, or the Linux Browser, the browser has the cryptographic functionality of more than 128 bits and the use of digital certificate; any type of terminals that can access an network can be used in the present invention, for example, personal computer (PC) 100, Palm PC 160, a personal digital assistant with mobile phone communication (PDA, such as using windows CE) 170, tablet PC 180, Multi-functional device such as mobile phone 190 or GPRS hand set with camera and WAP wireless application protocol functions, on-line interactive net TV 200 or IA (information appliance) 210, and the like. When there is video or voice in addition to digital data in the information on the transmitting side, it is converted to digital data first and then transmitted, it is converted to video or voice at the receiving side after reception. By text-to-voice converting technology, the Internet interface and voice portal are used on the telephone.

P2P (peer-to-peer) mode can seek for the exchange of audio-visual and text files without passing through the central control system of the network, such as the Napster sharing transmission software provides the sharing and download of music files. When P2P mode is used in the present invention, for example, a personal networked terminal 100 searches for any other personal networked terminals 160, 170, 180, 190, 200 and 210, which provide association lists of associations of mutual and loan to download lists of associations, when a plurality of personal networked terminals trust one another and agree on the items recorded on the same list of association, it is submitted to a web site of an association to implement as an association of mutual aid loan, each participating personal networked terminal becomes an association foot terminal of the system of the present invention. A web site of any type can be implement as an association web site, such as personal portal of telephone web site, financial web site, web site of a credit card company, post office web site, and portal web site qualified for operating network fund flowing mechanism.

The payment means for fund flowing of the association used by the association feet in the present invention may be the use of, for example credit card, financial card, paper cheque, cash, or electronic cheque. The payment and reception of association fund between the feet of an association or between the association feet and the web site of the association may make use of telegraphic money order, cheque and postal order. Debit-cards using the band accounts as payment vouchers may deduct association fund or receive and pay the total association fund from accounts (immediately or subscriptively). Before the initiation of an association, if an association foot has insurance on trust protection of the credit and debt relationship of the beneficiary, the insurance company that takes the insurance will be responsible for paying of the association funds to each of the other feet on the association list.

In terminology used by the present invention, for example, a network fund flow provider 130 refers to a bank, post office, bank of financial card or credit card/bank debit-card company used by on association foot (card holder) for accept and payment of fund flow of the association fund in a secure network association of mutual aid loan. A web site of the association refers to the web site that controls and manages the association feet on the association list to perform the transaction of the secure network association of mutual aid loan, the web site of the association plays the role of a service provider. An association foot refers to a participant of the secure network association of mutual aid loan who has input a form into to the web site and has been agreed by the web site. The network fund flow provider 130 may use the network fund flowing mechanisms, such as the SET (secure electronic transaction) network fund flowing mechanism or the SSL (secure socket layer) network fund flowing mechanism. Or the on-line payment may be performed by the use of non-SET network fund flowing mechanism voucher made by the cooperation of the bank 130 and the digital certificate authority 140.

The details that can be used in the specific implementation of the present invention are as follows: when an association foot has already participated in a secure network association of mutual aid loan, regardless whether the foot has already won a bid, a transferee or assignee may undertake the rights and duties of the remaining terms of the association (transfer assignment) under the agreement of all the other association feet on the association list. The web page of the web site 120 of the association provides information about the establishment of an association, a user may click and chose to input, for example, the desired bidding method of an association of mutual aid loan, the number of feet, the type and basic amount of the association fund, the number of terms of the association, the amount of money for bidding on the date of each term of the association, and etc, then the web site of the association will automatically try to calculate the interest and the derived organization and result of the association. Foot A input his/her member user's ID into the web page of the web site of the association, the credit class of the foot A appraised by the web site of the association may be displayed, for example 1, 2, 3, 4, and 5, wherein 1 is the best class. The appraisal of the class is helpful for foot members to select an appropciate foot member of initiation of an association. If a bank provides service of web site of association of mutual aid loan to its own clients, the credit classes of the clients of the bank are filtered in advance, and different amounts of association fund risks that the bank wishes to take are given to foot members of different classes. The association list may be a electronic document set by real time interactive dialog via the network of more than one association feet or by on-line game software having contents of association of mutual air loan, and one of the association feet on the list is elected to input the numbered association list into the web site of association to implement an association of mutual aid loan. The web site of association may be responsible for control and management of the association fund of each term under the agreement of all the association feet on the list of the association. Each of the feet may make an agreement in advance with the bank that he/she has an account therein to deduct the amount of association fund and transfer it to an account designated by the winner of the bid. The association fund can also be electronic currency (savings) deducted from the IC smart card of the association foot. The name of the winner of a bid may be published non-anonymously on the web site of the association under the agreement of all the association feet on the association list.

The web site of association assigns a user's password to an association foot for accessing the web site of the association, after the web site has obtained the necessary personal materials of the association foot and the association foot has become an association member of the web site. Or the web site of association gives the member association foot a portable password changer of the type of visually obtaining the password which changes synchronously with that of the web site (for example changes every minute), the member association foot accesses the web site after usually obtaining the password with it.

The methods for traditional association of mutual aid loan are usually inside bid and outside bid. In addition to inside bid and outside bid without head of association, the present invention may use any method for bidding without head of association with mutual confidence and agreement among the association feet. The rule for determining the winner of bid may be any well known deterministic rule. The association foot who bids the highest amount of bidding money is selected by the web site of the association as the winner of the bid, if there are two or more feet bid the same amount of bidding money, the winner is determined by the web site using electronic lots drawing, unless there are other conventions among the parties concerned, for example, the person whose bidding is opened first being the winner; the feet who have already won bid on previous dates of bidding are not allowed to bid again, that is, each share of the association is limited to win the bid once. Because the present invention has the advantage that any association foot who has not won a bid may bids as many times as desired before the closing date of a term of the association, the foot whose bidding date recorded on the association list is earlier than the other feet bidding the same highest amount of money may become the winner. The formula for the total association fund of each term of the association of inside bid is: $inside=($D−$X)(p−n)+$D(n−1). The formula for the total association fund of each term of the association of outside bid is: $outside=$D(p−n)+Σn−1, n−2, n−3, . . . , (p−1)($D+$X). The total association fund won by the winner at the first term of the inside bid association is $inside=($D−$X)(p−1). The total fund won by the winner at the second term of the inside bid association is $inside=($D−$X)(P−2)+$D. The total fund won by the winner at the third term of the inside bid association is $inside=($D−$X)(p−3)+2$D. The total fund won by the winner at the pth term of the inside bid association is $ inside=(p−1)$D. The total association fund won by the foot winning the bid of first term of the outside bid association is $ outside=$D(p−1). The total fund of the second term is $ outside=$D(p−2)+($D+$X)n=1. The total fund of the third term is $ outside=$D(p−3)+($D+$X) n=1+($D+$X)n=2. The total fund of the pth term is:

$outside=$D(p−n)+($D+$X)n=1+($D+$X)n=2+ . . . ($D+$X)n=(p−1)

wherein, n: the nth term of the association, n=1,2, . . . p, the association is carried out by dividing into p terms

p: the total number of association feet of the association of mutual aid loan; the number of terms.

$D: association funds (the basic amount of money agreed by all association of feet before the initiation of the association).

$ inside: The total association fund collected by the winner foot of the nth term of the inside bid association of mutual aid loan.

$X: The bidding amount of money (bid) of the winner foot of the nth term of the association of mutual aid loan.

($D−$X): The amount of money that one of the feet except the winner of the nth term should loan to the winner of the nth term in the inside bid mode.

$ outside: The total association fund collected by the winner foot of the nth term of the outside bid association of mutual aid loan.

$D(p−n): The amount of money that a foot who has not get won any bid till the nth term should loan to the winner of the nth term in the outside bid mode.

Σn−1, n−2, n−3 . . . (p−1)($D+$X): The amount of money that each of the feet who has already won a bid on the previous date of association should loan to the winner of the nth term according to the amount of money that the foot has previously won, in the outside bid mode.

One embodiment of the data processing method of the secure network system of association of mutual aid loan according to the present invention comprises the following steps:

(a) there are at least three or more association feet on an association list, wherein one of the feet inputs his/her personal user's ID and personal member password, and then inputs the association list, the items recorded on the list include: the name, address, telephone number and email address of each of the association feet, the type and basic amount of association fund, the date of initiation, the dates of each term of the association, mode of the association, agreement on the amount of money paid for each bid, agreement on the time of opening the bid, agreement on the path of flowing of the association fund, agreement on the flowing mechanism of fund selected by the association feet, time limit for the association feet to pay the association fund, the method for handling unable continuation of the association caused by the feet being unable to pay their association funds to the web site of the association within the time limit or other events, and user's ID code of each association foot at the web site of the association;

(b) checking the user's ID codes, if the result of checking determines that there is an association foot on the association list who is not a qualified member of the web site of the association, a message indicating that this list of association can not be established is created and output to the association foot inputting the list;

(c) assigning a number m as the number of the association list, determining that there are p association feet (p=3,4,5,6 . . . ) in the association no. m, assigning a different number k for each of the p association feet of the association no. m (k is a random number), determining that one foot number can only be collected into one association number, and designating an association password w used by the association foot no. k for the association no. m;

(d) combining the association no. m, association foot no. k, association password w and the plain text of a web site of the association to form an association initiation message of association no. m and foot no. k, outputting it to the association foot of foot no. k, and publishing relevant materials of the initiation of the association no. m on the web page of the web site of the association of mutual aid loan;

(e) before the initiation date of the association, each of the feet of the association no. m individually inputs the user's ID and the user's password of the web site of the association to access the web page of the web site of the association, to input the association number m, the foot number k, and the association password w, and then to select a displayed button displaying agreement of initiation of the association no. m for the feet to input their selections;

(f) if the result of checking indicates that one foot of the association no. m does not agree with the initiation of the association no. m, a message indicating that the initiation of an association with the association list can not be established is created by the web site of the association and output to the foot who has input the association list, otherwise, a message indicating the successful initiation of the association no. m is output to each of the feet;

(g) at least one association foot no. k of the association no. m inputs the user's ID and password of the web site of the association to access the web page of the web site of the association to input the association number m, foot number k, and association password w, and to select a displayed button displaying a date of bidding of the association of an unopened bid, and inputs his/her amount of money for bidding;

(h) checking whether there is any association in the association no. m which has passed the date for opening a bid but not opened yet according to the agreement on the date of opening a bid, if so, determining the winner foot no. of the bid of the date of this term of the association, and updating and publishing the process and results of the bidding and materials on the flowing of the association funds, and paying the association fund of this term of the association to the winner foot, according to the agreement on the flowing path of the association fund and the agreement on the flowing mechanism of the association fund selected by the feet; and

(i) if the result of checking indicating that more than one feet of the association no. m have not paid the association fund after the time limit or other events which cause the association unable to continue, a message indicating that the association can not be continued is published on the web site of the association, and notifying each foot to do according to the method for handling unable continuation of the association.

In one embodiment of the present invention, the items recorded on the association list further comprise:

the web address and email address of the web sire of the association and all items that should be recorded according to the provisions of the law;

if the initiation of the association is unsuccessful after inputting the association list into the web site of the association, the date of initiation of the association is the automatic invalidation time limit of the association list;

an electronic contract of the association of mutual aid loan;

the name, address, telephone number, and email address of the joint liability guarantor of each of the feet;

a method for determining the winner foot of the bid by the web site of the association, if no foot makes any bidding in any term of the association;

the agreement on flowing path of the funds of each term of the association comprises:

after each of the association feet has paid the association fund to the web site of the association before the time limit of payment, the web site of the association pays the total association fund to the winner foot; or

each of the association feet pays the association fund to the winner foot by oneself individually according to the result of the opening of the bid, and inputs the materials on the flowing of the funds to the web site of the association, where the materials are published, and the winner foot inputs the acknowledgement of the materials on each of the flowings of the fund to the web site of the association;

if the association of mutual aid loan cannot be continued due to the failure of the association feet to pay the association fund to the web site of the association or other events, the method for handling this comprises: notifying the winner feet that the association fund of each term should be paid to the web site of the association on the date of each term, and the web site pays the average fund to each of the feet who have not won any bid, or notifying the feet having already won a bid of returning the total fund of the association won by him/her to the feet having not won any bid within the time limit agreed on the association list, each of the feet having won a bid pays or returns the association fund using a reverse path for the flowing of the association fund, then the materials on the flowing of the fund are input into the web site of the association and published, and then each of the feet inputs acknowledgment of the materials on each flowing of the fund;

after the date of expiration of each term of the association, the web site of the association informs each of the feet of the results of the process of the association; and

each of the association feet having dual digital key pairs, one being an encryption certificate for encrypting and decrypting the messages being communicated between the association foot and the web site of the association, and the another being a signing certificate, for performing digital signature of the messages transmitting between the foot and the web site of the association.

In an embodiment of the present invention, if the listed items on the association list have not been recorded in detail all the articles of the association, all association feet must conform to the articles stipulated by the law.

In an embodiment of the present invention, the association list is one of a plurality of web page forms, the plurality of web page forms are set by the web site of the association and published on that web site for selection and use by the association feet.

In an embodiment of the present invention, when an association foot inputs the association number m, association foot number k and association password w, and selects at least one of the displayed buttons displaying an association date of unopened bid on the web page of the web site of the association, when inputting the bidding amount of money, the bidding amount of money input this time is used to replace the bidding amount of money input last time.

In an embodiment of the present invention, if none of the foot nos. having not won any bid of the association no. m inputs any bidding amount of money before the expiration of any from of the association, the winner foot no. is determined term the foot nos. having not won any bid of the association no. m using electronic lots drawing published by the web site of the association.

Another embodiment of the method of the secure network system of association of mutual aid loan according to the present invention comprises the following steps:

an association foot inputs a message including an association list for requesting the initiation of an association;

after determining that each of the association feet listed on the association list is a member of the web site and the items recorded in the association list conform with the stipulations by law, a message for initiating an association is created, the message for initiating an association includes an association no. assigned to that association list, foot nos. assigned to each of the feet, and the method of lots drawing to be used when no association foot makes any bidding before the expiration of the association, and the message for the initiating an association is delivered to each of the association feet listed on the association list, respectively;

after determining that a message indicating agreement with the message for the initiation of an association individually input by each of the feet listed on the association list has been received before the date of initiating the association listed on the list, outputting a message indicating the successful initiation of the association to each of the feet listed on the association list;

at least one of the feet listed on the association list inputs his/her bidding information, before the date of any term of the association listed on the list and the bid of which having not been opened yet;

after the opening of a bid that having not been opened after the expiration of its date of bidding of this association no., outputting a message of bid opening individually to each of the feet, and updating and publishing the results of the association process and materials on the flowing of the association funds; and

if the association of mutual aid loan can not be continued due to certain reasons, a message of the stopping of the association is output to each of the feet of the association no., respectively, this message for stopping the association is the method for handling the unable continuation of the association recorded in the association list.

Wherein, the association list is an electronic document set with mutual negotiation and mutual confidence and agreement, and combined by at least three or more feet themselves listed on the association list or combined by the web site of the association.

Wherein, the web site of the association is of the qualification of legal financial service and authorized to use one or more mechanisms of flowing funds over the network.

Wherein, the association list is created by mutually downloading the list of other feet via the network by one or more feet using peer to peer mode, and is negotiated and agreed with mutual confidence and understanding of each of the feet, and the association list is named.

Digital certificate mechanism and keys may be further used in an embodiment of the present invention, the date processing method of the present invention may further comprise the following steps:

before a message is input to the web site of the association by each of the feet, the message is encrypted using the public key of the web site of the association by each of the feet, respectively, and then digitally signed with the secret key of that foot, and then concatenated with the plain text desired to be sent to the web site of the association by the foot, and then the message is sent to the web site of the association; and

before a message is output to each of the feet by the web site of the association, the message is encrypted with the public key of the foot at the receiving end by the web site of the association, and digitally signed with the secret key of the web site of the association, and then concatenated with the plain text intended to send to the foot at the receiving end by the web site of the association and then output to the foot at the receiving end.

In the embodiment of the present invention, updating and publishing the results of the association process and materials on flowing of the association funds may further include the updating of the agreement on the path of flowing of the funds of each term:

before the time limit for paying the association fund, each of the association feet pays the association fund to the web site of the association, then the web site of the association pays the total association fund to the foot winning the bid, or

a foot individually pays the association fund to the foot winning the bid according to the result of opening of the bid, and then inputs the materials on the flowing of the fund to the web site of the association, which then publishes those materials, and then the foot winning the bid inputs acknowledgement of the materials on the flowing of each received fund to the web site.

In the embodiment of the present invention, the mode of the association on the association list is determined by the inside bid formula of the total fund of the each term of the association or the outside bid formula of the total fund of each term of the association:

the inside bid formula of the total fund of each term of the association:

$inside=($D−$X)(p−n)+$D(n−1);

the outside bid formula of the total fund of each term of the association:

$outside=$D(p−n)+Σn−1, n−2, n−3, . . . (p−1)($D+$X), where:

the association foot who bids the highest amount of money is the winner foot of the nth term of the association, and any foot who has already won a bid on the previous association dates is not allowed to bid again,

n: the nth term of the association, n=1, 2, 3 . . . p, the association of mutual aid loan is divided into p terms,

p: the total number of association feet participating in the association (number of terms),

$D: association fund (basic amount of money of each term agreed on by the feet before the initiation of an association).

$ inside: the total association fund collected by a winner foot of the nth term of the inside bid association (total amount of association fund),

$X: the amount of money bidden by the winner foot in the nth term of the association,

($D−$X): the amount of money that each of the feet except the winner foot of the nth term of the association should lend to the winner of the nth term of the association of inside bid mode,

$ outside: the total association fund collected by the winner foot of the nth term of the outside bid association (total amount of association fund),

$D(p−n): the amount of money that a foot having not get won any bid should lend to the winner of the nth term of the outside bid association,

Σn−1, n−2, n−3 . . . (p−1)($D+$X): the amount of money that each of the feet who has already won a bid should lend to the winner of the nth term of the association according to the amount of association fund won by him/her in the previous term of the association.

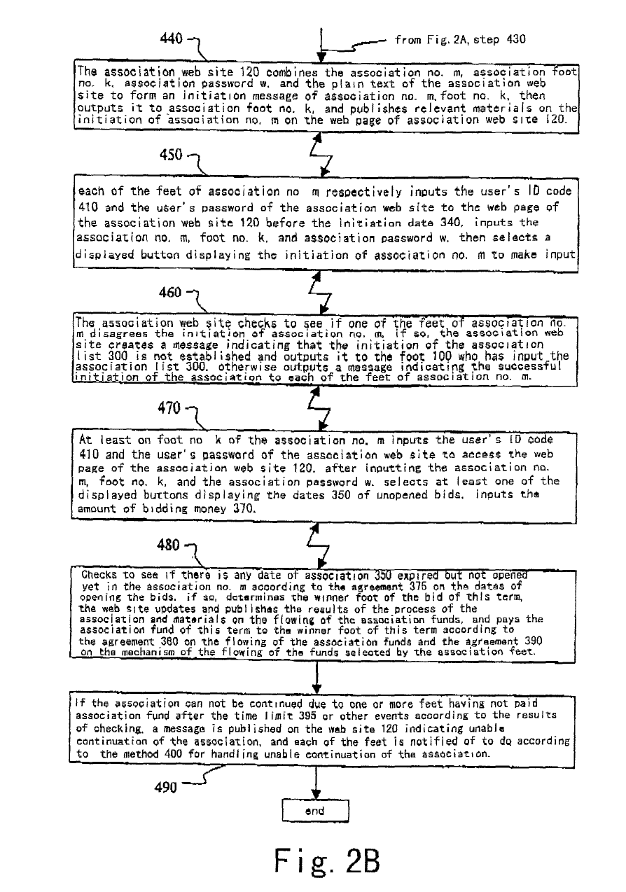

FIGS. 2A and 2B illustrate the steps of the specific embodiment of the present invention, typically there are three or more association feet on the association list of an association. A web site 120 of an association in FIG. 1 controls and manages 7 feet 100, 160, 170, 180, 190, 200, 210 of a plurality of feet registered on this web site to perform the secure Internet association of mutual aid loan. At the beginning of the steps, one of the 7 association feet, for example 100, inputs his/her personal user's ID and password, then inputs an association list 300 of mutual confidence and agreement of the 7 feet into the web site 120 of the association, the items 310 recorded on the list include: the name, address, telephone number and email address 320 of each of the association feet, the type and basic amount of association fund 330, the initiation date 340 of the association, dates 350 of each term of the association, mode of the association 360, agreement on the amount of bidding money 370, agreement on the time of opening the bids 375, agreement on the path of flowing of the association funds 380, agreement on the mechanism of flowing of funds selected by the feet 390, the time limit for each of the feet to pay the association fund 395, method for handling unable continuation of the association due to the foot's failure to pay the association fund within the time limit or other events 400, and the user's ID code 410 of each of the association feet on the web site of the association. At step 420, the web site 120 of the association checks the user's ID code 410. If the result of check indicates that one of the feet on the list 300 is not a qualified member of the web site 120 of the association, a message indicating that the association list can not be established is made and output to the foot 100 who inputs the association list 300 (step 425). At step 430, the web site 120 of the association assigns an association number m to the association list 300, determines that there are p association feet (p=3,4,5,6 . . . ) in the association no. m (for example, 3385), assigns each of the p feet (in this example, there are 7 feet) in the association no. m a foot no. k, where k is a random number, for example, the foot no. of the foot 100 in FIG. 1 is eu Oct. 14, 2010, wherein Oct. 14, 2010 may be in the format of year, month, and date. It is determined that one foot no. can only be collected into one association no. and the foot no. k is assigned a password w used for the association no. m. At step 440, the web site 120 of the association combines the association no. m, foot no. k, password w of the association, and the plain text of the web site of the association to form a message of initiation of the association of the association no. m and foot no. k, and then output this message to the foot of foot no. k, and publishes relevant materials on the initiation of the association of association no. m on the web page of the web site 120 of the association.

At step 450, each of the feet of association no. m inputs individually the user's ID code 410 and the user's password of the web site of the association into the web page of the web site 120 of the association before the date 340 of initiation of the association, after inputting the association number m, foot number k and password w of the association, then selects a displayed button displaying agreement of the initiation of association no. m for input. At step 460, if the results of checking by the web site 120 of the association indicate that one of the feet of the association no. m does not agree to initiate the association no. m, the web site 120 of the association creates a message indicating unsuccessful initiation of the association by the association list 300, and outputs it to the foot 100 who inputs the association list 300, otherwise outputs a message indicating the successful initiation of the association no. m to each of the association feet.

At step 470, at least one foot no. k of the association no. m inputs the user's ID 410 and user's password to the web site of the association to access the web page of the web site 120 of the association. After inputting the association no. m, the foot number k, and the association password w, that foot selects at least one displayed button displaying the dates 350 of the association that the bids of which have not been opened and inputs the amount of bidding money 370. At step 480, it is checked if there is any bid that has passed the date 350 of the association but has not yet been opened in association no. m according to the agreement 375 on the dates of opening of bids. If so, the winner's foot number of this term of the association is determined, and the results of the process of the association and the materials on the flowing of the funds are updated and published on the web site, then the association fund of this term is paid to the winner foot according to the agreement 380 on the path of flowing of the association funds and agreement 390 on the mechanism of flowing of the funds selected by the association feet. At step 490, if the association of mutual aid loan can not be continued due to the checking results indicating one or more feet of the association no. m having not paid his/her association fund within the time limit 395 or other events, a message indicating the unable continuation of the association is published on the web site 120 of the association ,and each of the feet is notified of doing according to the method 400 for handling unable continuation of the association of mutual aid loan.

1. A data processing method for a secure network system of an association of mutual aid loan;
comprising the steps of:
controlling and managing a plurality of terminals by an association web site, the association web site accepting the users of the terminals as members of the association, and receiving association lists input by each of the terminals;
publishing a message indicating the initiation of an association to each of the terminals of the association feet listed on the association list if the web site acknowledging the establishment of the association list, and receiving messages of agreement on the initiation of the association from the terminals;
receiving bidding message input from the terminals of the association feet by the wed site;
outputting message of opening a bid to each of the association feet after confirmation of opening a bid by the web site; and
outputting a message indicating the stopping of the association from the web site to each of the terminals of the association feet if it is discovered that the association cannot be continued.

2. The method according to claim 1, wherein each of the association feet makes anonymous bids on the web site via his/her terminal under the control and management of the web site of the association, the web site makes anonymous opening of the bids, then each of the feet pays the association fund to the web site, then the web site collects all of the association funds and forwards them to the foot who wins the bid, or each of the association feet pays his/her association fund to the winner foot individually.

3. The method according to claim 1 or 2, wherein the messages and electronic contracts trausmitled between the association web site and each of the feet are encrypted by using keys and digital signatures to protect from fraudulent bidding by real (false) association feet.

4. A data processing method for a secure network system of an association of mutual aid loan, comprising the steps of:
(a) an association list including at least three or more association feet, wherein one of the feet inputs an association list after imputting his/her user's ID and member's password, the items recorded on the association list include: the name, address, telephone number and email address of each of the association feet, the type and basic amount of the association fund, date of initiation of the association, date of each term of the association, mode of the association, agreement on the amount of money of bidding, agreement on the dates for opening bids, agreement on the path of flowing of the association funds, agreement on the mechanism of flowing of the funds selected by the association feet, time limit for the association feet to pay their association funds, the method for handling unable continuation of the association due to the association feet's failure to pay the association fund to the association web site within the time limit or other events, and the user's ID code of each of the association feet used for web site of the association;
(b) checking the user's ID code, if an association foot on the association list is not a qualified member of the web site of the association according to the result of the checking, a message indicating that the association list can not be established is created and output to the association foot who has input the association list;
(c) assigning an association number m for the association list, determining that there are p feet (p=3,4,5,6 . . . ) in the association no. m, assigning a different association foot number k (k is a random number) to each of the p feet in the association no. m, determining that one association foot no. can only be collected into one association no., and assigning an association password w used by the association foot no. k for the association no. m;
(d) combining the association number m, foot number k, association password w, and a plain text of the association web site to form a message for initiating an association for the association no. m and foot no. k, then outputting it to the foot of the foot no. k, and publishing the relevant materials on the initiation of the association no. m on the web page of the association web site;
(e) before the date of initation, each of the association feet of the association no. m inputs his/her user's ID code and user's password for the association web site to access the web page of the association web site, inputs the association number m, the foot number k, and the association password w, then selects a displayed button displaying agreement on the initiation of the association no, m and for the association foot to input his/her selections;
(f) if the results of the checking indicate that one foot of the association no. m does not agree with the initiation of the association no. m, a message indicating that the initiation of the association by the association list is not established, is created by the association web site and output to the association foot who has input the list, otherwise, a message indicating the successful initiation of the association is output to each of the feet of the association no. m;
(g) at least one association foot no. k of the association no. m inputs his/her user's ID code and user's password for the association web site to assess the web page of the association web site, inputs the association number m, foot number k and association password, and then selects at least one displayed button displaying the date of a bid having not been opened yet, and inputs the amount of money of bidding;
(h) checking if there is any bid that has passed the date for opening but not been opened yet, according to the agreement on the dates for opening of the bids, if so, determining the winner's foot number of this term of the association, updating and publishing the results of the process of the association and the materials on the flowing of the association funds on the web site, and paying the association fund of this term of the association to the winner foot according to the agreement on the path of flowing of the association funds and the agreement on the mechanism of flowing of the funds selected by the association feet; and
(i) according to the results of checking, if the association can not be continued due to one or more feet of the association no. m have not paid their association funds within the time limit, or other events, a message indicating that the association can not be further continued is published on the association web site, and each of the association feet is notified of doing according to the method for handling unable continuation of the association of mutual aid loan.

5. The method according claim 4, wherein the items recorded on the association list further include:
the web address, email address of the association web site, and the items that should be recorded by the web site required by the law;
the initiation date of the association will be the automatic invalidation time limit of the association list, if it fails to initiate the association after the input of the association list to the association web site;
an electronic contract of the association;
the name, address, telephone number, and email address of an joint liability guarantor of each of the feet;
a method for determining the winner foot of bid by the web site of the association, if no foot makes any bidding in any term of the association;
the agreement on the flowing path of the funds of each term of the association comprises:
after each of the association feet has paid the association fund to the web site of the association before the time limit of payment, the web site of the association pays the total association fund to the winner foot, or
each of the association feet pays the association fund to the winner foot by oneself individually according to the result of the opening of the bid, and inputs the materials on the flowing of the fund to the web site of the association, where the materials are published, and the winner foot inputs the acknowledgement of the materials on each of the flowing of the fund to the web site of the association;
if the association of mutual aid loan can not be continued due to the failure of the association feet to pay the association fund to the web site of the association within a time limit or other events, the method for handling this comprises: notifying the feet having already won a bid of paying the association fund of each term that should be paid by him/her to the web site of the association on the date of each term, and the web site pays the average fund to each of the feet who have not won any bid, or notifying the feet having already won a bid of returning the total fund of the association won by him/her to the feet having not won any bid within the time limit agreed on the association list, using a reverse path for the flowing of the association fund, then the materials on the flowing of the fund are input into the web site of the association and published, and then each of the feet inputs acknowledgement of the materials on each flowing of the fund;
after the date of expiration of each term of the association, the association web site informs each of the feet of the time limit for the results of the process of the association; and
each of the association feet having dual digital key pairs, one being an encription certificate for encrypting and decrypting the messages being communicated between the association foot and the association web site, and the another being a signing certificate for performing digital signature on the messages being communicated between the foot and the association web site.

6. The method according to claim 4 or 5, wherein if the listed items on the association list have not been recorded in detail all the articles of the association, all association feet must conform to articles stipulated by laws.

7. The method according to claim 4 or 5, wherein the association list is one of a plurality of web page forms, the plurality of web page forms are set by the association web site and published on that web site for selection and use by the association feet.

8. The method according to claim 4, wherein when an association foot inputs the association number m, association foot number k, and association password w, selects at least one of the displayed buttons displaying an association date of unopened bid on the web page of the association web site, and inputs the bidding amount of money, the bidding amount of money input this time is used to replace the bidding amount of money input last time.

9. The method according to claim 4, wherein, if none of the foot nos. having not won any bid of the association no. m inputs any bidding amount of money before the expiration of any term of the association, the winner foot no. is determined from the foot nos. having not won any bid of the association no. m using electronic lots drawing published by the association web site.

10. A method for a secure network system of association of mutual aid loan, comprises the following steps:
inputting a message including an association list for requesting the initiation of an association by an association foot;
creating a message for initiating an association, after determining that each of the association feet listed on the association list is a member of the web site and the items recorded in the association list conform with stipulations by laws, this message including an association number assigned to that association list, foot number assigned to each of the association feet, and the method of lots drawing to be used when no association foot makes any bidding before the expiration of each term of the association, and delivering the message for initiating an association to each of the association feet listed on the association list, respectively;
outputting a message indicating the successful initiation of the association to each of the feet listed on the association list, after determining that a message indicating agreement with the message for the initiation of an association individually input by each of the feet listed on the association list has been received before the date of initiating the association listed on the list;
inputting bidding information by at least one of the feet listed on the association list, before the date of any term of the association listed on the list and the bid of which having not been opened yet;
after the opening of a bid that having not been opened yet after the expiration of the date of bidding of this association number, outputting a message of bid opening individually to each of the feet, and updating and publishing the results of the association process and materials on the flowing of the association funds; and
if the association of mutual aid loan can not be continued due to certain reasons, sending a message of the stopping of the association to each of the feet of the association no., respectively, this message for stopping the association is the method for handling the unable continuation of the association recorded in the association list.

11. The method according to claim 1 or 4 or 10, wherein, the association list is an electronic document set with mutual negotiation, mutual confidence and agreement of at least three or more feet listed on the association list, after their combining by themselves or through the association web site.

12. The method according to claim 1 or 4 or 10, wherein the association web site is of the qualification of legal financial service and authorized to use one or more mechanisms of flowing funds over the network.

13. The method according to claim 1 or 4 or 10, wherein the association list is created by mutually downloading the lists of other feet via the network by one or more feet using peer to peer mode, and is negotiated and agreed with mutual confidence and understanding of each of the feet, and the association list is named.

14. The method according to claim 1 or 4 or 10, wherein digital certificate mechanism and keys are further used, the method further comprises the following steps:
before a message is input to the association web site by each of the feet, the message is encrypted using the public key of the association web site by each of the feet, respectively, and then digitally signed with the secret key of that foot, and concatenated with the plain text desired to be sent to the association web site by a foot, and then the message is sent to the association web site, respectively; and
before a message is output to each of the feet by the association web site, the message is encrypted with the public key of the foot at the receiving end by the association web site, then digitally signed with the secret key of the association web site, and then concatenated with the plain text intended to send to the foot at the receiving end by the association web site, and then output to the foot at the receiving end.

15. The method according to claim 10, wherein the updating and publishing of the results of the association process and materials on flowing of the association funds further comprises the agreement on the path of flowing of the association funds of each term:
before the time limit for paying the association fund, each of the association feet pays the association fund to the association web site, then the association web site pays the total association fund to the winner foot, or
each of the feet individually pays the association fund to the winner foot according to the result of opening of the bid, and then inputs the materials on the flowing of the fund to the association web site, which then publishes those materials, and then the winner foot inputs acknowledgement of the materials on the flowing of each received fund.

16. The method according to claim 1 or 4 or 10, wherein the mode of the association on the association list is determined by the following inside bid formula of the total fund of each term of the association or the outside bid formula of the total fund of each term of the association:
the inside bid formula of the total fund of each term of the association: $ inside=($D−$X)(p−n)+$D(n−1);
the outside bid formula of the total fund of each term of the association: $outside 32 $D(p−n)+Σn−1,n−2,n−3 . . . (p−1)($D+$X), where:
the association foot who bids the highest amount of money is the winner foot of the nth term of the association, and any foot who has already won a bid on the previous association dates is not allowed to bid again,
n: the nth term of the association, n=1,2,3 . . . p, the association of mutual aid loan is divided into p terms,
p: the total number of association feet joining the association (number of terms),
$inside: the total association fund collected by a winner foot in the nth term of the inside bid association (total amount of association fund),
$X: the amount of money bidden by the winner foot in the nth term of the association,
($D−$X): the amount of money that each of the feet except the winner foot of the nth term of the association should lend to the winner of the nth term of the association of inside bid mode,
$ outside: the total association fund collected by the winner foot of the nth term of the outside bid association (total amount of association fund),
$D(p−n): the amount of money that each of the feet having not get won any bid should lend to the winner foot of the nth term of the association of outside bid mode,
Σn−1, n−2, n−3, . . . , (p−1)($D+$X): the amount of money that each of the feet who has already won a bid should lend to the winner of the nth term of the association of outside bid mode according to the amount of association fund obtained by him/her in the previous term of the association.

17. A secure network system of association of mutual aid loan, comprises:
an association web site;
a plurality of terminals connected to the web site via a network, the terminals have already registered on the web site as association foot members of the association and been controlled and managed by the web site, each of the terminals is configured with association software for implementing the association and a browser software; and
means for connecting said terminals to the server of the web site via the Internet;
wherein, an association list set by three or more feet terminals with the feet's mutual confidence and agreement is input to the server of the association web site by one of the terminals of the association feet whose name is listed on the association list;
the server of the association web site determines that the association list conforms with the provisions of relevant laws of association and that all the terminals of the association feet members agree on the initiation of the association, the association web site accepts the bidding of each of the terminals of the association feet having not won any bid on the association list, determines the winner foot of each term of the association of the list, and updates and publishes the result of the process of the association and the materials on the flowing procedure of the association funds.

18. The system according to claim 17, wherein the terminals of the association feet further utilize a cryptography software stored in the association foot's IC smart card to encrypt and decrypt the message being communicated between the terminals and the web site, utilize the IC smart card to store digital certificates, and utilize secret keys of the association feet in the IC smart card to perform digital signatures.
